(19) United States
(12) Patent Application Publication
(10) Pub. No.: US 2025/0280794 A1
(43) Pub. Date: Sep. 11, 2025

(54) Refillable Scent Ball and Multipurpose Cat Toy

(71) Applicant: Lynn Bahr, Marietta, GA (US)

(72) Inventor: Lynn Bahr, Marietta, GA (US)

(21) Appl. No.: 18/600,860

(22) Filed: Mar. 11, 2024

(51) Int. Cl. A01K 15/02; A01K 5/01; A01K 5/02

(52) U.S. Cl. CPC A01K 15/025

(57) ABSTRACT

A cat toy including an elongated handle and a spherical hollow scent ball that secretes catnip or other pet friendly substances. The system is designed for both play with a user, or for a cat to play alone as a cat can latch onto the hollow ball and access the pet friendly substances while an owner holds onto the handle, or of the cat's own accord. The hollow ball is divided into an upper portion and a lower portion which are removably attached to accommodate catnip and pet friendly substances, and is disposed to be refillable.

### BACKGROUND OF THE INVENTION

### Field of the Invention

The present invention refers to a device that entertains cats by disseminating cat treats which are retained inside of the toy device. In one embodiment, the device resembles a lollipop with small holes on top to secrete a cat attractant substance when it is added inside of the lollipop resembling toy. In another embodiment, a candy ball, jawbreaker ball or other such candy like toy is envisioned. This allows one to entertain a beloved pet by rewarding them with treats and/or a cat attractant, such as silvervine.

### Description of the Related Art

Over the years, many different types of catnip toys (e.g., toys that look like balls, logs, or mice) have been used by pet owners to entertain their pets. While these traditional catnip toys are capable of effectively entertaining pets for extended amounts of time, they typically do so in a manner that is difficult for cat owners to actively participate.

Within the concurrent art, various devices exist designed to dispense cat nip. One such system illustrates a toy for cats which is in the shape of a ball that cats can lick and chew on because catnip is enclosed inside of the ball structure.

Another system illustrates a plush log that resembles a pillow that cats can hold and play with while secreting ca at attractant for their enjoyment. Additional systems illustrate a cat toy for use in entertaining cats that is in the form of a mouse. The toy also secretes cat attractant and can squeak for a cat's amusement.

Accordingly, herein an enhanced animal toy system is disclosed. More particularly, the cat toy which includes the capability to disseminate a cat attractant, such as silvervine and affords the capability to be refilled, while also providing multiple modes of human involvement and thus accommodate the needs of both cat owners and cats alike.

### SUMMARY OF INVENTION

The instant apparatus and system, as illustrated herein, is clearly not anticipated, rendered obvious, or even present in any of the prior art mechanisms, either alone or in any combination thereof. Disclosed is a versatile system and method for creating and utilizing systems for animal, specifically cat, entertainment. Thus, the embodiment of the instant apparatus is illustrated herein.

In this specification, a “user” is anyone interacting with the cat or cat toy, including a person refilling the cat attractant device, as described herein. The words “user” and “device” (or “toy”) are, in some cases, used interchangeably, since the device is filled and operated by the user.

The instant system, which in some embodiments, comes under the umbrella of the Pop 'n Purr™ toy line, accomplishes numerous tasks, including entertainment for cats while additionally allowing for cat owners to actively participate in the entertainment process, if desired.

In addition, the instant device is modeled after a lollipop, a candy ball or even a jawbreaker, such that a cat, can latch onto the ball part of the toy, or the handle of the lollipop, to provide different modes of play. Focusing on the cat owner, in the lollipop embodiment, a cat owner can hold onto the handle part of the toy. In the candy ball or jawbreaker embodiment, the owner can roll the ball continuously to provide human involvement with the playing process, and thus joy for cat and owner as well.

In one embodiment, there may be small apertures located on an upper area of the upper portion of the ball part of the toy that secrete catnip or a cat attractant, or another catnip like substance, for a cat's enjoyment. Furthermore, the ball attached to the handle is hollow to accommodate the cat attractant. Moreover, the ball may be opened latitudinally to refill the cat attractant when applicable. Thus, this device makes entertaining cats as inclusive as possible to allow for as many endeavors as possible with the beloved animal.

The foregoing has outlined the more pertinent and important features of the present invention in order that the detailed description of the invention that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel cat toy described below is intended to embrace all such alterations, modifications, and variations that fall within the spirit and scope of the appended claims.

There has thus been outlined, rather broadly, the more important features of the refillable cat toy in the numerous embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

Advantages of the present device will be apparent from the following brief description of exemplary embodiments thereof; which description should be considered in conjunction with the accompanying drawings. Having thus described the invention in general terms, reference will now be made to the accompanying drawings, which are not necessarily drawn to scale, and wherein:

FIG. 1 is a top right perspective view of one embodiment of the present device, refillable scent ball system or refillable multipurpose cat toy, including the handle member attachment to be used by both animal and user.

FIG. 2 is a bottom right perspective view of one embodiment of the present device including the handle device attached for utilization by both animal and human user.

FIG. 3 is a top plan view of one embodiment of the present device including the handle device attached for utilization by both animal and human user.

FIG. 4 is a bottom view of one embodiment of the present device including the handle device attached for utilization by both animal and human user.

FIG. 5 is a front view of one embodiment of the present device including the handle device attached for utilization by both animal and human user.

FIG. 6 is front perspective view of a preferred embodiment of the present device including the handle device attached for utilization by both animal and human user, and additionally with the upper portion removed to illustrate the system in an opened state for refilling.

FIG. 7 is a front perspective view of an embodiment of the present device without the handle device removed and with the upper portion removed to illustrate the system in an opened state for refilling.

FIG. 8 is a front perspective view of a one embodiment of the present device, without the handle member deployed, in an inverted portion for dissemination of a pet friendly substance or cat attractant.

### DETAILED DESCRIPTION OF THE SEVERAL EMBODIMENTS

The detailed description set forth below is intended as a description of presently preferred embodiments of the system and does not represent the only forms in which the present system may be construed and/or utilized. The description sets forth the functions and the sequence of the steps for producing the system and accompanying apparatus. However, it is to be understood that the same or equivalent functions and sequences may be accomplished by different embodiments and are intended to be encompassed within the scope of the system.

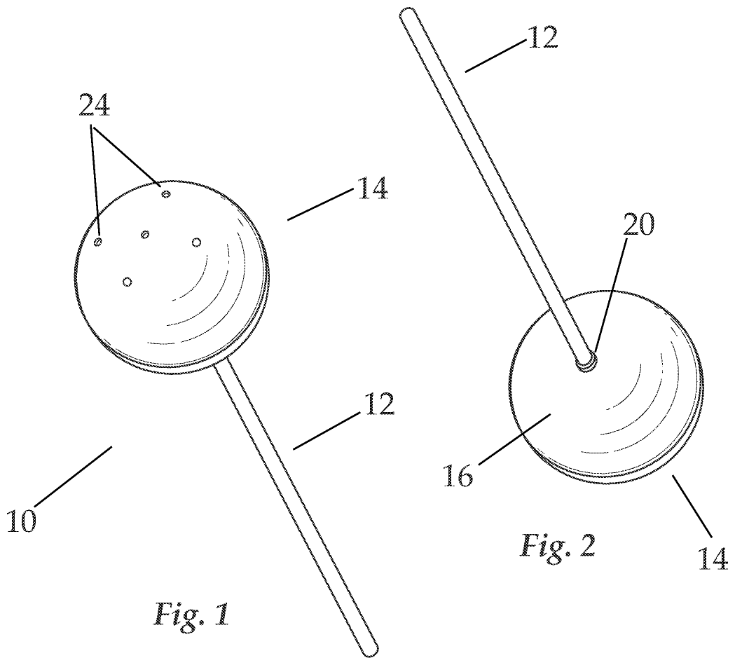

FIG. 1 illustrates a top right perspective view of one embodiment of a refillable scent ball system 10 or refillable multipurpose cat toy 10 wherein the refillable multipurpose cat toy 10 may be made from durable polymeric or plastic material, rolled/layered paper and properly glue. However, wood, rope, rubber, etc. can be utilized to craft refillable multipurpose cat toy 10. In a preferred embodiment, a handle member 12, which may comprise material qualities such as layered paper compactly rolled, composite materials or even polymeric materials, constructed into a tight shaft. The handle may comprise and elongated handle with a cylindrical or rectangular profile.

Additionally, the refillable scent ball system 10 may comprise a hollow spherical member or ball member 14 may comprise two pieces, and upper portion 18 and a lower portion 16, which may comprise polymeric construction, and may be latitudinally split to allow separation of the upper portion 18 and the lower portion 16 of the hollow spherical member or ball member 14 (see FIG. 5).

FIG. 2 discloses a bottom right perspective view of one embodiment of the refillable scent ball or refillable cat toy 10. The handle member 12 is disposed to insert into a receiving aperture 20 disposed on the lower most area of the lower portion 16 of hollow spherical member or ball member 14. In addition, in some embodiments, the handle member 12 attaches to the lower ball 16 via an adhesive, such as glue, or a fastener.

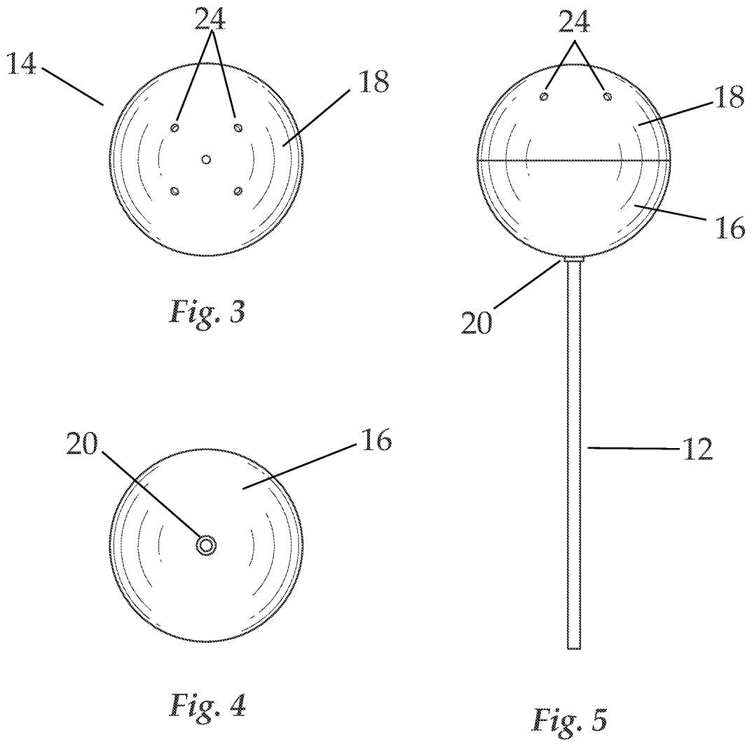

FIG. 3 is a top plan view of one embodiment of the present refillable scent ball 10. In this embodiment, the upper portion 18 of the hollow spherical member 14 may further comprise a plurality of apertures 24. Each aperture 24 is used in a dissemination process to allow a cat to gain access to and experience the pleasurable effects of catnip and other such pet friendly substances or cat attractants 26 (see FIG. 8). For instance, silver vine, which is an organic and all-natural catnip alternative, or other such healthy alternatives may be employed.

FIG. 4 is a bottom view of one embodiment of the present device showing the lower portion 16 receiving aperture 20 which is disposed to act as the attachment point between the lower portion 16 and the handle member 12.

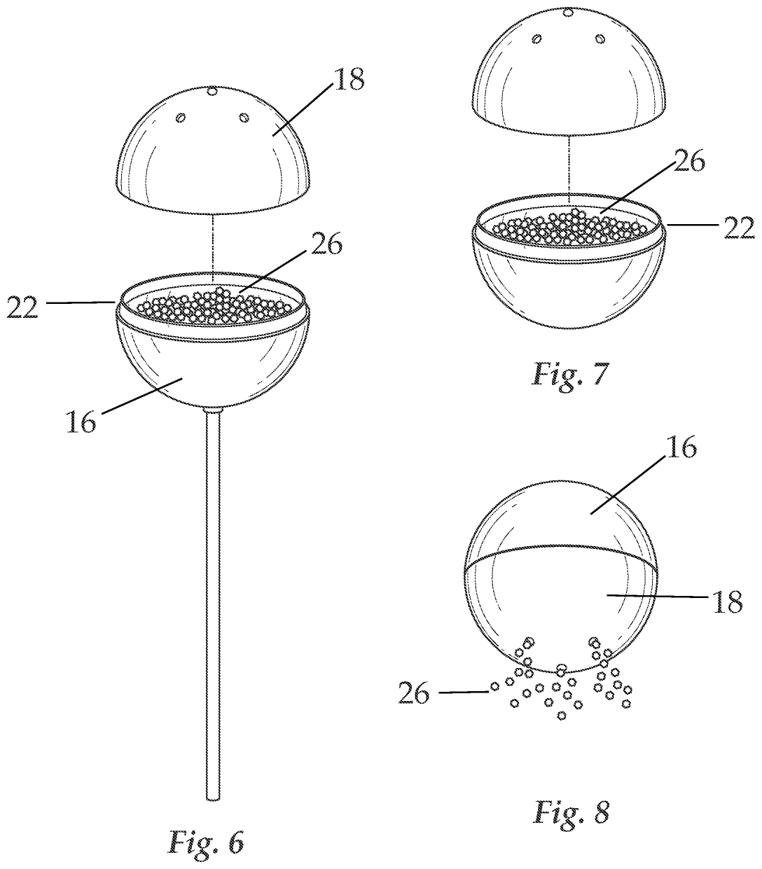

FIG. 5 is a front view of one embodiment of the present device in a closed state. In this embodiment, the upper portion 18 is disposed to be attached to the lower portion 16 latitudinally in order to mate and seal with the lower portion 16, to create the hollow spherical member 14 in full form. To this end, the lower portion 16 comprises a circumferential lipped ridge 22 spanning the rim area of the lower portion 16, the lipped ridge 22 disposed for mating with the upper portion 18 (see FIG. 6).

Additionally, the upper portion 18 may comprise a circumferential indentation spanning the upper portion 18 rim area and configured to receive the lipped ridge 22. When cat toy 10 is in a closed state, the lipped ridge of ball bottom 16 fits seamlessly inside the continuous indentation of ball top 18.

FIGS. 6 and 7 illustrate front perspective views of a one embodiment of the refillable scent ball system 10 wherein the upper portion 18 is removably attached to the lower portion 16. As illustrated, when the upper portion 18 and the lower portion 16 are attached, the hollow spherical member 14 is fully formed and configured to accommodate containment of catnip and other pet friendly substances or cat attractants 26. The user accessible, chambered mechanism not only allows for limited animal access, it also enables a user to refill the cat toy with pet friendly substances or cat attractants 26 for extended use beyond eventual depletion.

FIG. 8 is a front perspective view of a one embodiment of the present device, without the handle member deployed, in an inverted portion for dissemination of a pet friendly substance 26 through a set of apertures 24 located on an upper area of the upper portion 18 of the hollow spherical member 14. The set of apertures 24 may contain any number of apertures in a range from one (1) to ten (10), in one embodiment. Additionally illustrated is the dissemination of the pet-friendly substances or cat attractants 26 such as silvervine.

In one embodiment, the refillable scent ball system 10 provides a multi-sensory playtime experience may be had through a system disclosing a single stem rose edition lollipop designed to keep a cat engaged for hours on end. Inside of each lollipop, a quantity of premium Cloud Nine™ silvervine may be included. Cloud Nine™ silvervine is a lab-certified natural cat attractant that drives cats wild with delight by emitting a captivating scent and providing a feeling to cats.

Moreover, Cloud Nine™ silvervine is non-addictive, safe and natural cat attractant that cats find simply irresistible. The experience doesn't have to end when the cat attractant depletes as the user can refill the system with the cat's favorite attractant or tasty treats to encourage endless entertainment for the animal. The system is thus designed with both the cat's well-being, and the user convenience, in mind as the system may be washable, refillable, and may be pre-loaded with Cloud Nine™ silvervine.

In one embodiment, the lollipops may comprise a single stem roselike lollipop design, wrapped in green and red crepe paper, perfect for the cat to rip apart and enjoy safely. In another embodiment, the lollipop spherical member may measure approximately 1.75 inches in diameter and stands at 5.5 inches in overall height, including the handle, thus providing the ideal playtime proportions.

In an additional embodiment, the system may be deemed the Pop 'n Purrs!™ and may comprise a configuration with a diameter of approximately 1.75 inches and 4 inches width in the wrapper.

In yet another embodiment, as highlighted in FIG. 8, a candy ball, jawbreaker ball or other such candy like toy is envisioned. Thus, both the cat and the owner, are provided at least two modes of play as in the lollipop embodiment, a cat owner can hold onto the handle part of the toy; and, in the candy ball or jawbreaker embodiment, the owner can roll the ball continuously to provide human involvement with the playing process, and thus joy for cat and owner as well.

What is claimed is:

1. A refillable multipurpose pet toy comprising:
a hollow spherical member comprising:
a lower portion; and,
an upper portion, wherein the upper portion comprises a set of dispensing apertures;
wherein said ball further comprises a set of apertures.

2. The refillable multipurpose pet toy further comprising a handle member.

3. The refillable multipurpose pet toy of claim wherein the handle member comprising a cylindrical profile.

4. A cat toy comprising:
an elongated handle having a first end and a second end; and
a hollow spherical member;
wherein said ball further comprises a set of apertures and is attached to said first end of said elongated handle.

5. The cat toy of claim 4 in which the hollow spherical member is evenly and latitudinally divided into an upper portion and a lower portion.

6. The cat toy of claim 5 wherein the upper portion is removably attached to the lower portion.

7. The cat toy of claim 5 further comprising a set of apertures on the upper portion of the hollow spherical member.

8. The cat toy of claim 5 in which the lower portion comprises an aperture configured to receive the first end of the elongated handle.

9. The cat toy of claim 8 wherein the hollow spherical member is attached to said elongated handle by insertion of the first end of the elongated handle through the aperture of the lower portion of the hollow sphere.

10. The cat toy of claim 9 wherein the first end of said elongated handle is fixedly attached to the lower portion of the hollow spherical member with an adhesive substance.

11. The cat toy of claim 10 wherein the elongated handle comprises a cylindrical profile.

12. The cat toy of claim 6 further comprising a set of apertures located on an upper area of the upper portion disposed for the dissemination of a cat attractant substance.
